(19) United States
(12) Patent Application Publication
(10) Pub. No.: US 2006/0143617 A1
(43) Pub. Date: Jun. 29, 2006

(54) Method, apparatus and system for dynamic allocation of virtual platform resources

(76) Inventors: Robert C. Knauerhase, Portland, OR (US); Vijay Tewari, Portland, OR (US); Scott H. Robinson, Portland, OR (US); Mic Bowman, Beaverton, OR (US); Milan Milenkovic, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/027,740

(22) Filed: Dec. 29, 2004

(51) Int. Cl. G06F 9/46

(52) U.S. Cl. 718/104

(57) ABSTRACT

A method, apparatus and system for transparent and dynamic resource allocation in a virtualized environment is disclosed. An embodiment of the present invention enables a resource allocation module to dynamically evaluate resource requests from various clients and allocate the resources on a virtual host as available. The resource allocation module may additionally monitor resource usage and dynamically reallocate resources as appropriate.

### BACKGROUND

Corporate networks today are becoming increasingly complex, having large numbers of clients and numerous servers to service the clients. Information Technology (“IT”) professionals typically handle the tasks of tracking and allocating the server resources to service all the clients on the network. Thus, for example, if a corporation has 100 users, the corporate IT professionals may determine that one or two servers on the network should be dedicated to handling all email for these 100 users. Regardless of whether all the resources on each server are being utilized by the email needs of the 100 users, these resources will not be available to any other requests that a client may have. There is currently no efficient scheme by which resources in a network may be allocated automatically and dynamically to various clients.

Similar resource management issues exist in a virtualized environment. Virtualization technology enables a single host computer running a virtual machine monitor (“VMM”) to present multiple abstractions and/or views of the host, such that the underlying hardware of the host appears as one or more independently operating VMs. Each VM may function as a self-contained platform, running its own operating system (“OS”) and/or a software application(s). The VMM manages allocation of resources on the host and performs context switching as necessary to cycle between various virtual machines according to a round-robin or other predetermined scheme. As the number of VMs on a system increases, so does the overhead on the system.

There is no current scheme by which a VMM may dynamically allocate resources to various VMs. Additionally, there is no current scheme by which a VMM may service and/or respond to requests from remote clients (i.e., requests originating from a remote location, not on the local VM host) for resources on the VM host.

### BRIEF DESCRIPTION OF THE DRAWINGS

The present invention is illustrated by way of example and not limitation in the figures of the accompanying drawings in which like references indicate similar elements, and in which:

FIG. 1 illustrates an example of a typical VM host;

FIG. 2 illustrates an example of a resource allocation module in a virtualized environment according to an embodiment of the present invention; and

FIG. 3 is a flowchart illustrating an embodiment of the present invention.

### DETAILED DESCRIPTION

Embodiments of the present invention provide a method, apparatus and system for dynamic resource allocation on a virtual platform. More specifically, a resource allocation module on a virtual machine (“VM”) host may perform dynamic resource allocation on a VM host. Reference in the specification to “one embodiment” or “an embodiment” of the present invention means that a particular feature, structure or characteristic described in connection with the embodiment is included in at least one embodiment of the present invention. Thus, the appearances of the phrases “in one embodiment,” “according to one embodiment” or the like appearing in various places throughout the specification are not necessarily all referring to the same embodiment.

Embodiments of the present invention may provide benefits in various distributed systems, such as traditional enterprise data centers and large grid computing networks. Grid computing supports transparent sharing, selection, and aggregation of distributed resources, offering consistent and inexpensive access of the resources to grid users. By providing access to the aggregate computing power and virtualized resources of participating networked computers, grid computing enables the utilization of temporarily unused computational resources in various types of networks (e.g., massive corporate networks containing numerous idle resources).

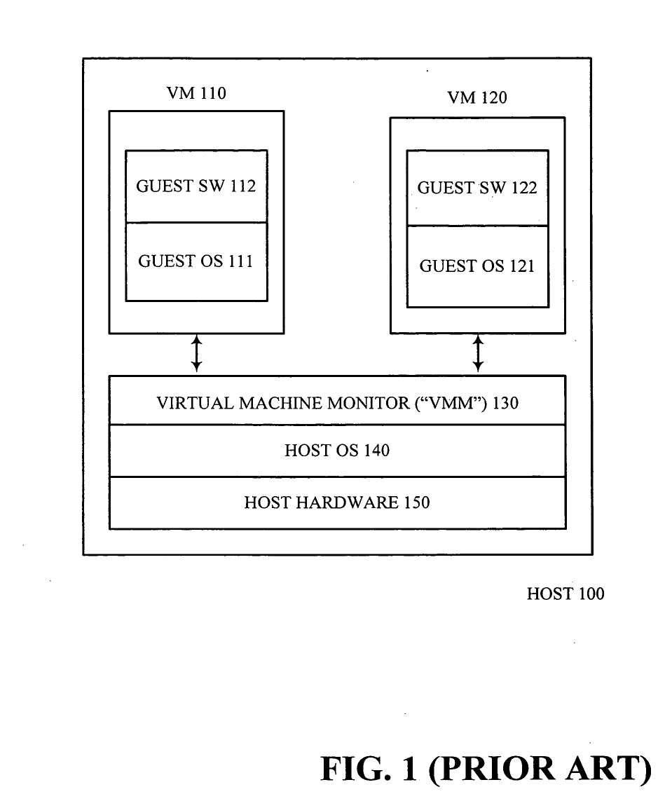

According to embodiments of the present invention, various features of virtualization may be leveraged to provide automatic and dynamic resource allocation. FIG. 1 illustrates an example of a typical virtual machine host platform (“Host 100”). As previously described, a virtual-machine monitor (“VMM 130”) typically runs on the host platform and presents an abstraction(s) and/or view(s) of the platform (also referred to as “virtual machines” or “VMs”) to other software. Although only two VM partitions are illustrated (“VM 110” and “VM 120”, hereafter referred to collectively as “VMs”), these VMs are merely illustrative and additional virtual machines may be added to the host. VMM 130 may be implemented in software (e.g., as a standalone program and/or a component of a host operating system, illustrated as “Host OS 140”), hardware, firmware and/or any combination thereof. It is well known to those of ordinary skill in the art that although Host OS 140 is illustrated in FIG. 1, this component is not necessary in some VM host implementations and therefore may not be used.

VM 110 and VM 120 may function as self-contained platforms respectively, running their own “guest operating systems” (i.e., operating systems hosted by VMM 130, illustrated as “Guest OS 111” and “Guest OS 121” and hereafter referred to collectively as “Guest OS”) and other software (illustrated as “Guest Software 112” and “Guest Software 122” and hereafter referred to collectively as “Guest Software”). Each Guest OS and/or Guest Software operates as if it were running on a dedicated computer. That is, each Guest OS and/or Guest Software may expect to control various events and have access to hardware resources on Host 100. The VMM need not just project a representation of the physical platform or give direct access to resources. The VMM may also create new virtual devices (e.g. a network interface card (“NIC”)) while possibly using Host 110's processor and similar devices (e.g., another NIC) on Host 100 to emulate those virtual devices. The virtual platform presented to a given VM by VMM 130 may be a hybrid of virtual and physical elements. Therefore, within each VM, the Guest OS and/or Guest Software may behave as if they were, in effect, running on the virtual platform hardware (“Host Hardware 150”), supported by the VMM 130. In reality however, VMM 130 has ultimate control over the events and hardware resources (which may be physical or virtual as created by VMM 130), and allocates resources to the VMs according to its own policies. Recursive or layered VM schemes may also be possible, e.g., VM 110 may host another virtual host (which may appear to have behaviors like physical Host 100 or some other virtual host platform, or a hybrid platform.) These types of recursive schemes are well known to those of ordinary skill in the art and further description thereof is omitted herein in order not to unnecessarily obscure embodiments of the present invention.

According to embodiments of the present invention, various features of virtualization may be leveraged within distributed systems to provide enhanced resource management capabilities. Thus, for example, in one embodiment of the present invention, VM technology may be utilized within a grid computing network to enhance security and enable the grid computing environment to function in isolation from other processes. Virtualization may be implemented in a variety of ways within a grid computing environment without departing from the spirit of embodiments of the present invention. In an embodiment, VM technology may also be utilized within a traditional enterprise data center. Regardless of the implementation, embodiments of the present invention may automatically and dynamically allocate resources to various clients on a communications network. For the purposes of this specification, a “client” shall include remote clients coupled to the host VM via the communications network (e.g., in a distributed system) and/or VMs that reside locally on a host VM (e.g., in a standalone host). Such communications and/or connectivity may be continuous, periodic, and/or intermittent.

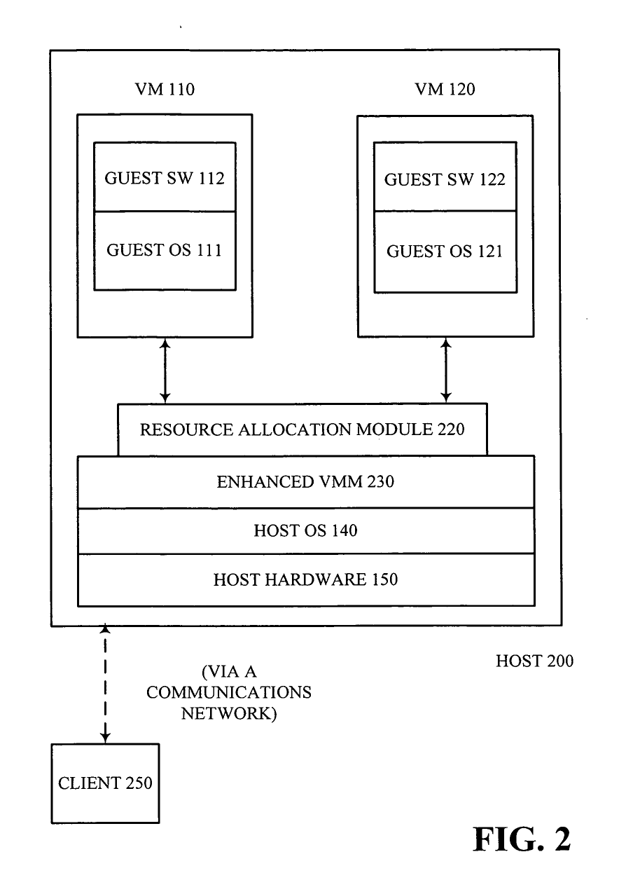

According to embodiments of the present invention, a resource allocation module may supplement the functionality of the VMM on a VM host by servicing requests from clients and performing dynamic resource allocation. As illustrated in FIG. 2, the resource allocation module (“Resource Allocation Module 220”) may comprise an additional component on Host 200, but embodiments of the present invention are not so limited. Instead, in an alternate embodiment, Resource Allocation Module 220 may be implemented as part of the VMM (“Enhanced VMM 230”) on Host 200. In an embodiment, Resource Allocation Module 220 may be implemented in a service VM, coupled to the VMM 130. In yet another embodiment Resource Allocation Module 220 may be implemented in a VMM-collaborative hosting operating system. Regardless of the embodiment, Resource Allocation Module 220 may be implemented in software, hardware, firmware and/or any combination thereof without departing from the spirit of embodiments of the present invention. Additionally, Enhanced VMM 230 may include various enhancements over existing VMMs, either to include the functionality of Resource Allocation Module 220 and/or to interact with Resource Allocation Module 220. It will be readily apparent to those of ordinary skill in the art that Enhanced VMM 230 may also be implemented in software (e.g., as a standalone program and/or a component of a host operating system), hardware, firmware and/or any combination thereof. The remaining descriptions herein assume an embodiment in which Resource Allocation Module 220 is implemented as a separate component on Host 200. This embodiment may provide improved reliability and/or security of the system.

In one embodiment, Resource Allocation Module 220 may monitor all requests for resources received by Host 200. Resource Allocation Module 220 may also create and/or provision VMs on Host 200 with the appropriate resources. Resource Allocation Module 220 may additionally receive notification (e.g., from Enhanced VMM 230) when a VM on Host 200 is destroyed, archived, put to sleep and/or hibernating. On one embodiment, this scheme enables Resource Allocation Module 220 to keep track of all the resources on Host 200 accurately. By monitoring all resources on Host 200 and managing the resources on Host 200 in conjunction with Enhanced VMM 230 (as described in further detail below), Resource Allocation Module 220 may dynamically allocate and/or adjust resource allocations as necessary. Resource Allocation Module 220 may allocate resources in various ways upon receipt of a request for resources from a client (“Client 250”). Client 250 is illustrated in FIG. 2 as a remote client, i.e., residing on a device remote from Host 200, but embodiments of the present invention are not so limited. Instead, in an alternate embodiment, Client 250 may comprise a VM on Host 200 (e.g., VM 110).

Resource Allocation Module 220 may be implemented in various ways to perform these monitoring and allocation tasks. Thus, for example, in a virtualized environment, Resource Allocation Module 220 may be configured to allocate resources to incoming client requests according to the actual resources available on Host 200, instead of the typical resource allocation scheme in virtualized environments by which each VM on Host 200 believes it has 100 percent of the host resources. In one embodiment, if no additional information is received from Client 250, Resource Allocation Module 220 may itself make a determination of how many resources it has available and allocate those resources to Client 250. Alternatively, Resource Allocation Module 220 may receive resource information from Client 250 (e.g., the minimum and/or maximum amount of resources that Client 250 requires) and utilize this information to determine whether it can allocate resources to Client 250.

In one embodiment, requests from Client 250 may include at least one platform parameter. Platform parameters may include, for example, processor utilization. Processor utilization may be expressed as anticipated central processing unit (“CPU”) utilization, either in absolute (“x MIPS”) or relative (“y % of a Pentium[PCG1]®4 processor at 3 GHz) terms, and/or as a function of load or other canonical work units as determined by benchmarking or other measurement. Another example of a platform parameter is network utilization, i.e., anticipated bandwidth consumption. Additional parameters may include, but are not limited to memory/storage utilization (e.g., anticipated amount of RAM or disk space (average or high-water mark)), specific peripherals (e.g., need for particular (virtual) peripherals; e.g. specific model of emulated NIC, desired display (local or remote), etc.), guest operating systems (e.g., requirement to have a Linux environment, or a specific version of Windows OS, etc.), software (e.g., requirement to have certain drivers, programs, libraries, or other optionally-installed logic in the environment), initial setup response time (latency), real-time/response time processing requirements and service intervals, required reliability or fault tolerance features (e.g. ECC protected memory), cost, secure storage requirements, secure software/certificates and attestation chains/dependencies, support for multiple (recursive) layers of virtualization (e.g. layered virtualization) and/or time period of day, week, month, year of anticipated use and/or duration. Initial (setup) response time typically dictates time parameters of how much initial latency can be tolerated in servicing a request. Thus, for example, in cases where long, sustained virtual machines are used, the client will often tolerate longer initial latencies in order to build a more highly customized VM environment (e.g. a web server presence for a company). Conversely, if the expected use is short, then the client may not be able to tolerate much initial setup work (e.g. for a one-time scientific computation), so a more generic, preconfigured VM may need to be used. Initial setup time may be explicit or may be inferred (and balanced) from other parameters.

In one embodiment, Resource Allocation Module 220 may also accept, as part of the client request and/or as other system configuration parameters or policies, conditions for suspending (hiberating the associated VMs) and/or terminating a client request. These conditions may, for example, include simple policies such as exceeding a parameter threshold. The parameter thresholds may include cost, duration of activity (e.g. wall clock time or CPU time), disk usage, loss of a contract, etc.

In one embodiment, Resource Allocation Module 220 may determine that it does not have sufficient resources to meet the request from Client 250. If so, Resource Allocation Module 220 may reject the request, or in the alternative, provide Client 250 with a suggestion for a reduced number of resources. In the latter case, if Client 250 accepts the reduction in resources, Resource Allocation Module 220 may then allocate the reduced resources to the VM. If, however, Client 250 determines that the reduced resources are not sufficient for its needs (or that it would like to maintain the original resources for some other reason), Client 250 may reject the proposal from Resource Allocation Module 220 and continue to look for adequate resources from a different host on the network.

In one embodiment, regardless of the amount of resources allocated to the VM requested by Client 250, Resource Allocation Module 220 may continuously monitor the VMs actual resource utilization. Thus, if the VM does not in fact utilize all the requested resources, in one embodiment, Resource Allocation Module 220 may dynamically and automatically reduce the resource allocation to that client, thus freeing up resources to allocate to other clients. Conversely, Resource Allocation Module 220 may determine that the VM requires additional resources and once again, these resources may be automatically and dynamically allocated. Regardless of the embodiment, Resource Allocation Module 220 may be configured to retain requested and/or actual resource information and utilize this information to service future client requests.

Thus, for example, if Client 250 makes a first request to Resource Allocation Module 220 for resources for an email server, this original request information and subsequent adjustments to the resources may be retained for future use. If Resource Allocation Module 220 then receives a second request (from Client 250 or any other client) for resources for another email server, if no additional information is specified by the requesting client, Resource Allocation Module 220 may utilize the previously retained information to determine an appropriate number of resources to allocate to the new request. Resource Allocation Module 220 may also share the previously obtained and stored information with various clients and other hosts on the network. Thus, for example, in a data center environment, Resource Allocation Module 220 may share this information with all the hosts on the network to allow all the hosts to better respond to future requests for similar applications.

In addition to requested and/or actual resource information, Resource Allocation Module 200 in an embodiment of the present invention may also retain information pertaining to clients, requests, applications, etc. This information may be updated in a database, together with actual resource measurements/utilization (e.g. using counters in the processor, chipset, OS, or management partition and/or other metrics/performance and utilization tracing facilities.). This database may, therefore, comprise a “history” of requests and resource utilization on Host 200 and the information in the database may be used to shape further decisions about how resources are allocated on Host 200. Thus, for example, based on the history information in the database, Resource Allocation Module 220 may be aware that if a VM is created on Host 200 to host a large database, the VM may include a large memory footprint and lots of I/O traffic. This type of information may enable Resource Allocation Module 220 to significantly increase its efficiency in numerous areas such as utilization, i.e., allocate resources more accurately and/or anticipate resource needs more accurately.

In one embodiment of the present invention, Resource Allocation Module 220 may monitor the various resources on Host 100 and constantly update its internal counters to maintain up to date resource availability. Thus, for example, Resource Allocation Module 220 may continuously keep track of processor utilization, front-side bus utilization, etc., by monitoring various counters on Host 100; some of these counters may be virtualized. Use of counters to track processor utilization is well-known to those of ordinary skill in the art and further description thereof is omitted herein in order not to unnecessarily obscure embodiments of the present invention. Additionally, as previously described, Enhanced VMM 230 may also provide Resource Allocation Module 220 with updated resource information each time a VM is created and/or destroyed. Thus, in one embodiment, Resource Allocation Module 220 may always be aware of the resource allocation and/or utilization on Host 200.

In an embodiment, Resource Allocation Module 220 may elect to “oversubscribe” Host 200. In other words, regardless of whether it has sufficient resources, Resource Allocation Module 220 may nonetheless allocate resources as the requests are received, on the assumption that on average, each request is unlikely to require the maximum amount of requested resources at the same time. In this embodiment, Resource Allocation Module 220 may be able to fulfill more requests and utilize the resources on Host 200 more efficiently. At the worst case, if all the clients who requested resources on Host 200 happen to utilize the maximum number of resources at the same time, Host 200 will be unable to execute all the requests from the various clients. Instead, only a subset of clients may be serviced. Resource Allocation Module 220 may optionally inform the client that it was unable to satisfy the original request, and/or recommend a larger set of resources, or another location where such resources may be acquired.

In an embodiment of the present invention, Resource Allocation Module 220 may utilize Globally Unique Identifiers (“GUIDs”) to identify clients, VM configurations, etc. GUIDs may be stored and retrieved from a database of history/configuration of key information. Additionally, in one embodiment Resource Allocation Module 220 may also perform “pattern matching” to identify similar (but not necessarily exactly the same) configurations or related history. Collections of GUIDs may be used to identify certain configurations. A GUID may also identify a given collection of GUIDs in a recursive manner. In various embodiments, Resource Allocation Module 220 may store information cataloged by time (e.g. heavy loads in day, light at night, etc. and/or based on day of week, month, and/or time of season/year, etc.).

In one embodiment, Resource Allocation Module 220 may create/configure and/or clone various VMs for later use. Thus, for example, Resource Allocation Module 220 may define a VM with a set of resource configurations and allow the VM to be dormant (e.g., in a sleep state). Alternatively, Resource Allocation Module 220 may clone a VM corresponding to a previous request, again allowing the cloned VM to be dormant until needed to service a client request, especially those that require (or seem to require, as implied by other request parameters) a short initial response setup time or latency. When a request comes in from Client 250, Resource Allocation Module 220 may compare the requested resources against one or more of these previously defined/cloned VMs to determine whether one of these VM is capable of meeting the request. In one embodiment, for example, Resource Allocation Module 220 may look for the smallest VM that satisfies the request. In an alternate embodiment, Resource Allocation Module 220 may look for the best fit between the requested resources and the predefined/cloned VMs. The best fit may or may not be a VM with less resources than requested. Various other schemes may be used to determine whether a predefined/cloned VM may satisfy the request.

In one embodiment, if Resource Allocation Module 220 determines that one of the predefined VMs is a good fit for the incoming request, it may then negotiate with Client 250, e.g., inform Client 250 that it has a VM that closely matches the requested resources. Client 250 may then have the option of accepting the VM with the alternate (substitutional) set of resources. If Client 250 accepts the VM, Resource Allocation Module 220 may then instantiate the VM. Since the predefined/cloned VM may already have an operating system and/or software associated with it, the new VM may be instantiated quickly. Some parameters (and configuration) for such predefined VMs may be instantiation/load-time adjustable. Other parameters (and configuration) for such predefined VMs may be dynamically adjustable. Such parameters or configuration may include, but are not limited to, software, devices (real or virtual), hardware, percentage of CPU time allotted, etc. Some adjustments may be purposefully postponed to satisfy the initial request, but later granted and/or implemented as demands on the VM diminish and/or as resources assigned to other VMs are released.

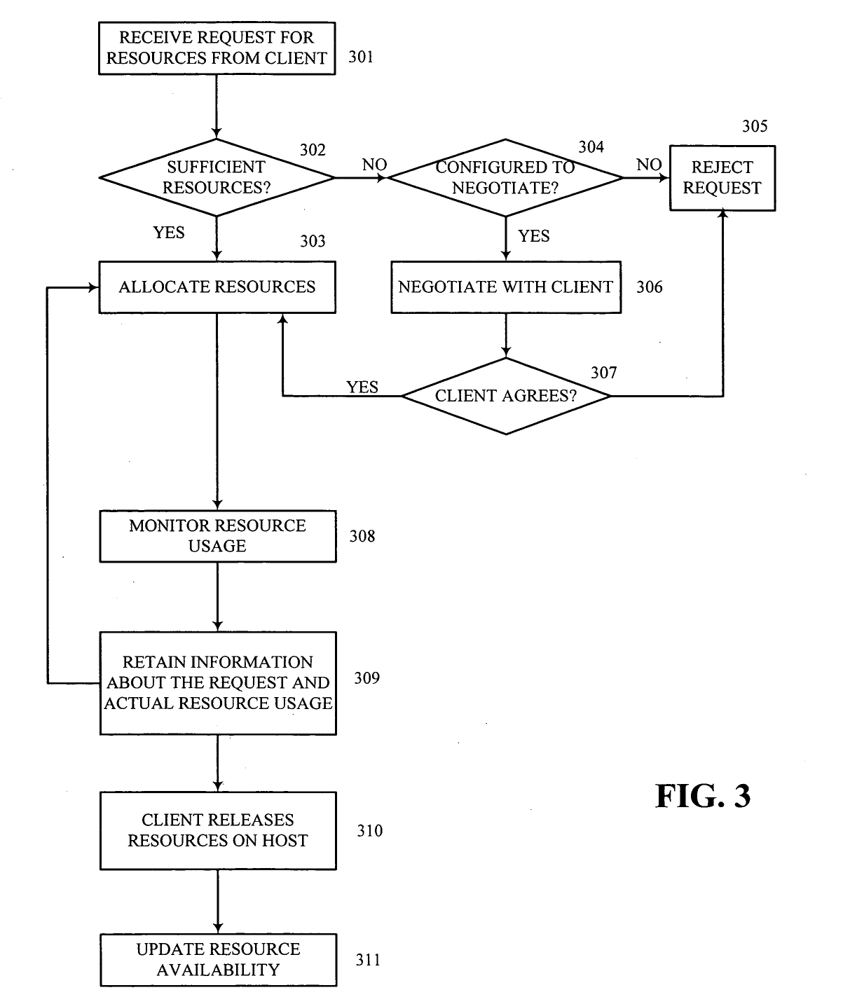

FIG. 3 is a flowchart illustrating an embodiment of the present invention. Although the following operations may be described as a sequential process, many of the operations may in fact be performed in parallel and/or concurrently. In addition, the order of the operations may be re-arranged without departing from the spirit of embodiments of the invention. Finally, certain operations that are typical, but not required (e.g., client authentication) are not shown herein in order not to unnecessarily obscure embodiments of the present invention. In 301, a request for resources from a client may be intercepted by a resource allocation module on a VM host. The request may be processed to determine whether there are sufficient resources on the host to fulfill the request 302. If there are sufficient resources, the resource allocation module may allocate those resources in 303 to the client making the request. If, however, there are not sufficient resources, in 304, the resource allocation module may determine based on its configuration whether to negotiate with the client in 304. If the resource allocation module is not configured to negotiate, it may reject the client's request in 305 and inform the client that it has insufficient resources to service the client's needs. If, however, the resource allocation module is configured to negotiate with the client, in 306, the resource allocation module may propose an alternate resource allocation to the client (i.e., different than the resource originally requested because the host does not have sufficient or identical resources to fulfill the request). The alternate resource allocation may include a subset or scaled back set of resources and/or substitution resources (e.g., resources that are functionally equivalent or similar, but not identical). If the client rejects the proposed resources in 307, then the process ends in 305. The client may thereafter reissue its request to an alternative host.

If, however, the client agrees to the alternative resources proposed by the resource allocation module, the module may allocate the resources to the client in 303. Thereafter, the resource allocation module may monitor the actual resource usage in 308 and retain this information, together with information pertaining to the original requests (e.g., the request was for a mail server) in 309. If necessary, the resource allocation module may adjust the resources, i.e. reallocate (expand, contract, change or substitute) resources in 303. This process may continue until the client releases the resources on the host in 310. If notified that the client resources have been released, the resource allocation module may update its resource availability information in 311.

The hosts according to embodiments of the present invention may be implemented on a variety of computing devices. According to an embodiment of the present invention, computing devices may include various components capable of executing instructions to accomplish an embodiment of the present invention. For example, the computing devices may include and/or be coupled to at least one machine-accessible medium. As used in this specification, a “machine” includes, but is not limited to, any computing device with one or more processors. As used in this specification, a machine-accessible medium includes any mechanism that stores and/or transmits information in any form accessible by a computing device, the machine-accessible medium including but not limited to, recordable/non-recordable media (such as read-only memory (ROM), random-access memory (RAM), magnetic disk storage media, optical storage media and flash memory devices), as well as mechanical, electrical, optical, acoustical or other form of propagated signals (such as carrier waves, infrared signals and digital signals).

According to an embodiment, a computing device may include various other well-known components such as one or more processors. Thus, the computing device (e.g., Host 100) may include any type of processor capable of executing software, including microprocessors, multi-threaded processors, multi-core processors, digital signal processors, co-processors, reconfigurable processors, microcontrollers and/or any combination thereof. The processors may be arranged in various configurations such as symmetric multi-processors (e.g., 2-way, 4-way, 8-way, etc.) and/or in other communication topologies (e.g., toroidal meshes), either now known or hereafter developed. The term “processor” may include, but is not necessarily limited to, extensible microcode, macrocode, software, programmable logic, hard coded logic, etc., capable of executing embodiments of the present invention.

The processor(s) and machine-accessible media may be communicatively coupled using a bridge/memory controller, and the processor may be capable of executing instructions stored in the machine-accessible media. The bridge/memory controller may be coupled to a graphics controller, and the graphics controller may control the output of display data on a display device. The bridge/memory controller may be coupled to one or more buses. One or more of these elements may be integrated together with the processor on a single package or using multiple packages or dies. A host bus controller such as a Universal Serial Bus (“USB”) host controller may be coupled to the bus(es) and a plurality of devices may be coupled to the USB. For example, user input devices such as a keyboard and mouse may be included in the computing device for providing input data. In alternate embodiments, the host bus controller may be compatible with various other interconnect standards including PCI, PCI Express, FireWire and other such current and future standards.

In the foregoing specification, the invention has been described with reference to specific exemplary embodiments thereof. It will, however, be appreciated that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A method for dynamically allocating resources on a virtual machine (“VM”) host, comprising:
receiving a request for resources from a client;
examining available resources on the VM host to determine if the request can be fulfilled;
determining if the resources are available on the VM host to fulfill the request;
if the resources are available on the VM host to fulfill the request, responding to the client that the request is granted; and
if the resources are not available on the VM host to fulfill the request, responding to the client that the request is denied.

2. The method according to claim 1 wherein responding to the client that the request is denied further comprises at least one of:
denying the request outright; and
offering the client an alternative set of resources.

3. The method according to claim 2 further comprising allocating the alternative set of resources to the client if the client accepts the offer for the alternative set of resources.

4. The method according to claim 2 further comprising:
defining a VM with a set of resources prior to receiving the request for resources;
upon receiving the request for resources, determining whether the VM satisfies the request for resources based on a predetermined methodology; and
if the VM satisfies the request for resources based on the predetermined methodology, offering the client the VM to satisfy the request.

5. The method according to claim 4 wherein the predetermined methodology includes determining a best fit between the resources and the VM.

6. The method according to claim 1 wherein if the resources are available of the VM host, responding to the client that the request is granted and further monitoring usage of the resources.

7. The method according to claim 6 further comprising adjusting the resources allocated to the client according to the usage of the resources.

8. The method according to claim 6 further comprising retaining information pertaining to at least one of the request for resources and the usage of resources.

9. The method according to claim 8 further comprising:
receiving a second request for resources;
evaluating the second request in light of the information retained pertaining to the at least one of the request for resources and the usage of resources by the client; and
if the resources are available on the VM host to fulfill the second request based on the evaluation, responding to the client that the second request is granted;

10. The method according to claim 1 wherein determining if the resources are available on the VM host to fulfill the request further comprises evaluating resources already allocated on the host.

11. The method according to claim 1 wherein determining if the resources are available on the VM host to fulfill the request further comprises evaluating actual resource usage on the host.

12. The method according to claim 1 wherein the request for resources includes at least one platform parameter.

13. The method according to claim 12 wherein the at least one platform parameter includes at least one of processor utilization, network utilization, memory utilization, specific peripherals, desired display, operating systems, software, initial setup response time, response time processing requirements, service intervals, fault tolerance features, cost, secure storage requirements, secure software, support for recursive layers of virtualization, time period of use, and duration of use.

14. The method according to claim 1 wherein if the resources are available on the VM host to fulfill the request and the request is granted, further receiving a request to release the resources.

15. A system for dynamically allocating resources in a distributed system, comprising:
a client in the distributed system;
a virtual machine (“VM”) host in the distributed system, the VM host capable of receiving a request for resources from the client;
a resource allocation module capable of examining available resources on the VM host to determine if the request for resources can be fulfilled, the resource allocation module further capable of responding to the client with one of a grant and a denial of resources.

16. The system according to claim 15 wherein the client and the VM host reside on a single device.

17. The system according to claim 15 wherein the client and the VM host reside on different devices.

18. The system according to claim 15 wherein the resource allocation module is further capable of offering the client an alternative set of resources if the VM host has insufficient resources available.

19. The system according to claim 16 wherein the resource allocation module is further capable of:
defining a VM with a set of resources prior to receiving the request for resources;
upon receiving the request for resources, determining whether the VM satisfies the request for resources based on a predetermined methodology; and
if the VM satisfies the request for resources based on the predetermined methodology, offering the client the VM to satisfy the request.

20. The system according to claim 19 wherein the predetermined methodology includes determining a best fit between the resources and the VM.

21. The system according to claim 15 wherein the resource allocation module is further capable of monitoring usage of resources by the client.

22. The system according to claim 21 wherein the resource allocation module is further capable of adjusting the resources allocated to the client.

23. The system according to claim 22 wherein the resource allocation module is further capable of retaining information pertaining to at least one of the request for resources and the usage of resources by the client.

24. An article comprising a machine-accessible medium having stored thereon instructions that, when executed by a machine, cause the machine to:
receive a request for resources on a VM host from a client;
examine available resources on the VM host to determine if the request can be fulfilled;
determine if the resources are available on the VM host to fulfill the request;
if the resources are available on the VM host to fulfill the request, respond to the client that the request is granted; and
if the resources are not available on the VM host to fulfill the request, respond to the client that the request is denied.

25. The article according to claim 24 wherein the instructions, when executed, further cause the machine to respond to the client that the request by:
denying the request outright; and
offering the client an alternative set of resources.

26. The article according to claim 25 wherein the instructions, when executed by the machine, further cause the machine to:
define a VM with a set of resources prior to receiving the request for resources;
upon receiving the request for resources, determine whether the VM satisfies the request for resources based on a predetermined methodology; and
if the VM satisfies the request for resources based on the predetermined methodology, offer the client the VM to satisfy the request.

27. The article according to claim 26 wherein the predetermined methodology includes determining a best fit between the resources and the VM.

28. The article according to claim 25 wherein the instructions, when executed, further cause the machine to allocate the alternative set of resources to the client if the client accepts the offer for the alternative set of resources.

29. The article according to claim 28 wherein the instructions, when executed, further cause the machine to monitor usage of the resources by the client.

30. The article according to claim 29 wherein the instructions, when executed, further cause the machine to adjust the resources allocated to the client according to the usage of the resources by the client.

31. The article according to claim 29 wherein the instructions, when executed, further cause the machine to retain information pertaining to at least one of the request for resources and the usage of resources by the client.

32. The article according to claim 31 wherein the instructions, when executed, further cause the machine to:
receive a second request for resources;
evaluate the second request in light of the information retained pertaining to the at least one of the request for resources and the usage of resources by the client; and
if the resources are available on the VM host to fulfill the second request based on the evaluation, respond to the client that the second request is granted;

33. The article according to claim 24 wherein the instructions, when executed, further cause the machine to determine if the resources are available on the VM host to fulfill the request by evaluating resources already allocated on the host.

34. The article according to claim 24 wherein the instructions, when executed, further cause the machine determine if the resources are available on the VM host to fulfill the request by actual resource usage on the host.
